(19) United States
(12) Patent Application Publication
(10) Pub. No.: US 2011/0301854 A1
(43) Pub. Date: Dec. 8, 2011

(54) Method of Determining Allele-Specific Copy Number of a SNP

(76) Inventors: Bo U. Curry, Redwood City, CA (US); Nicholas M. Sampas, San Jose, CA (US)

(21) Appl. No.: 13/073,766

(22) Filed: Mar. 28, 2011

Related U.S. Application Data
(60) Provisional application No. 61/352,686, filed on Jun. 8, 2010.

(51) Int. Cl. G06F 19/00; C40B 30/04

(52) U.S. Cl. 702/19; 506/9

(57) ABSTRACT

A method of estimating the allele-specific copy number of a SNP in a test genome is provided. In certain embodiments, the method involves: a) calculating a plurality of probability distribution functions that fit a plurality of log ratios indicating which alleles of a plurality of single nucleotide polymorphisms (SNPs) are present in diploid regions of a test and reference genome; and b) estimating the allele-specific copy number of a SNP of the test genome using said plurality of probability distribution functions.

### INTRODUCTION

The human genome has several types of variation which confer genetic differences between individuals. Single nucleotide polymorphisms (SNPs) are sites of single base changes which vary in at least 1% of the population. Copy number variants (CNVs) are larger regions of DNA which are duplicated or deleted with respect to a reference genome. Additionally, somatic alterations of the genome occur within subpopulations of an individual's cells or tissues. Such somatic aberrations are particularly important to cancer progression and potentially informative for therapeutics.

Methods for the determination of SNP alleles and copy number measurements are important to the research community for the diagnosis of disease, especially in cytogenetics and cancer. Researchers could benefit from the development of new methods for analyzing SNPs and copy number in human genomic DNA.

### BRIEF DESCRIPTION OF THE FIGURES

FIG. 1 schematically illustrates one exemplary method by which a SNP assay may be performed.

FIGS. 2 A-B, FIG. 2A shows: The distribution of uncorrected log ratios of SNP probes for a normal individual. The data show five peaks corresponding to the five possible ratios on integral AsCNs in the sample vs the reference. FIG. 2B The data of FIG. 2A after correction for the copy number of the reference sample. The black curve is the data, and the other curves are Gaussian fits to the three peaks. Three figures of merit are generated by the fit: Separation, the distance between the centers of the N=1 and N=2 peaks, GoodnessOfFit, Ambiguity.

FIG. 3 shows alignments of SNP data and CGH data mapped to their positions on chromosome 15, indicating copy number neutral (top) and non-copy number neutral (bottom) loss of heterozygosity.

FIG. 4 shows graphs of the number of SNPs called (left panel), and the number of SNPs correctly called for 12 HapMap samples (right panel).

FIG. 5 shows distributions of log2(signal) for SNPs with non-zero reference copy number can be used to identify a subset of SNPs with zero reference copy number which SNPs can be reliably assigned a zero copy number in the test sample.

FIGS. 6A and 6B. FIG. 6A shows data for a monoclonal predominantly tetraploid cancer cell line. The CGH probes are smoothed (14 point triangular) and fitted to copy numbers. The peaks are assigned to CN=2, 3, 4, 5, 6, 8 and 12, consistent with an aneuploid fraction of 0.99. FIG. 6B shows data for a mosaic, predominantly diploid cancer sample. The CGH probes are smoothed (28 point triangular) and fitted to copy numbers. The peaks are assigned to CN=0, 1, 2, 3, and 5, consistent with an aneuploid fraction of 0.56.

FIG. 7. When the aneuploid fraction is much less than 1.0, SNPs in different aneuploid regions will have different average AsCN, and the distribution cannot be fit to discrete global peaks. However, usually a large number of SNPs will be in copy-neutral regions, and these “diploid” SNPs can be fitted to three Gaussian distributions, corresponding to AsCN of 0, 1, and 2 in the diploid regions.

FIG. 8 shows two examples of SNP fits in aneuploid regions of the sample of FIG. 6B which are large enough to see in the distributions—a whole chromosome amplification of chr 5 and a hemizygous deletion on chr 11. The thin red curve is the modeled Gaussian log ratio distribution for the four possible AsCN states in each aberration. The thin black curve is the actual log ratio distribution within the aberrant region.

FIG. 9 is a graph showing that when the contributions from all aberrant intervals are summed together, the overall modeled distribution (red) closely approximates the observed distribution (black). The data are from the sample of FIG. 7.

FIG. 10: CGH CN fit to a polyclonal aneuploid sample, showing the characteristic assignment of multiple peaks to the same total copy number.

FIG. 11A-D shows aberrant region workflow. 11A Fit 012 in diploid regions, 11B predicted mu, sigma, coefficient in aberrant regions of total copy number 3. 11C predicted mu, sigma, coefficient in aberrant regions of total copy no =4. 11D: With an aneuploid fraction of only 26%, this colon tumor sample has only small amplified regions that are relatively easy to fit.

FIG. 12 is a flow chart illustrating an embodiment of the method described herein.

### DEFINITIONS

The term “sample”, as used herein, relates to a material or mixture of materials, typically, although not necessarily, in liquid form, containing one or more analytes of interest.

The term “genome”, as used herein, refers to the nuclear DNA of an organism. The term “genomic DNA” as used herein refers to deoxyribonucleic acids that are obtained from the nucleus of an organism. The terms “genome” and “genomic DNA” encompass genetic material that may have undergone amplification, purification, or fragmentation. In some cases, genomic DNA encompasses nucleic acids isolated from a single cell, or a small number of cells. The “genome” in the sample that is of interest in a study may encompass the entirety of the genetic material from an organism, or it may encompass only a selected fraction thereof: for example, a genome may encompass one chromosome from an organism with a plurality of chromosomes. The terms “genome” and “genomic DNA” do not encompass cDNA (which is cDNA made from RNA).

However, as is well known, information about a cell's genome (e.g., about SNPs etc) can be obtained from examining cDNA from that cell.

The term “genomic region” or “genomic segment”, as used herein, denotes a contiguous length of nucleotides in a genome of an organism. A genomic region may be of a length as small as a few kb (e.g., at least 5 kb, at least 10 kb or at least 20 kb), up to an entire chromosome or more.

The terms “test”, as used herein with reference to a type of sample (e.g., a genome), refers to a sample that is under study.

The term “reference,” as used herein with reference to a type of sample, refers to a sample to which a test sample may be compared. A reference sample is generally the same species (e.g., where the species is human, or mouse, for example) as that of the test sample. The reference sample may represent an individual genome, e.g., of a cell line, or may represent either a physical pooling of the genomes of multiple individuals or a computational combination of data from a number of individuals. A “reference sample” presumes that the genotype of the reference sample is known. In some cases, the genotype of the reference sample is known from previously measured array results, or from sequencing. In other cases, the reference contains a region of known nucleotide sequence, e.g. a chromosomal region whose sequence is deposited at NCBI's Genbank database or other databases, for example.

The term “nucleotide” is intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the term “nucleotide” includes those moieties that contain hapten or fluorescent labels and may contain not only conventional ribose and deoxyribose sugars, but other sugars as well.

Modified nucleosides or nucleotides also include modifications on the sugar moiety, e.g., wherein one or more of the hydroxyl groups are replaced with halogen atoms or aliphatic groups, are functionalized as ethers, amines, or the likes. Nucleotides may include those that when incorporated into an extending strand of a nucleic acid enables continued extension (non-chain terminating nucleotides) and those that prevent subsequent extension (e.g. chain terminators).

The term “nucleic acid” and “polynucleotide” are used interchangeably herein to describe a polymer of any length, e.g., greater than about 2 bases, greater than about 10 bases, greater than about 100 bases, greater than about 500 bases, greater than 1000 bases, up to about 10,000 or more bases composed of nucleotides, e.g., deoxyribonucleotides or ribonucleotides, and may be produced enzymatically or synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions. Naturally-occurring nucleotides include guanine, cytosine, adenine, uracil and thymine (G, C, A, U and T, respectively).

The term “oligonucleotide”, as used herein, denotes a single-stranded multimer of nucleotides from about 2 to 500 nucleotides, e.g., 2 to 200 nucleotides. Oligonucleotides may be synthetic or may be made enzymatically, and, in some embodiments, are under 10 to 50 nucleotides in length. Oligonucleotides may contain ribonucleotide monomers (i.e., may be oligoribonucleotides) or deoxyribonucleotide monomers. Oligonucleotides may be 10 to 20, 11 to 30, 31 to 40, 41 to 50, 51-60, 61 to 70, 71 to 80, 80 to 100, 100 to 150 or 150 to 200, up to 500 or more nucleotides in length, for example.

The term “duplex” or “double-stranded” as used herein refers to nucleic acids formed by hybridization of two single strands of nucleic acids containing complementary sequences. In most cases, genomic DNA is double-stranded.

The term “complementary” as used herein refers to a nucleotide sequence that base-pairs by non-covalent bonds to a target nucleic acid of interest. In the canonical Watson-Crick base pairing, adenine (A) forms a base pair with thymine (T), as does guanine (G) with cytosine (C) in DNA. In RNA, thymine is replaced by uracil (U). As such, A is complementary to T and G is complementary to C. In RNA, A is complementary to U and vice versa. Typically, “complementary” refers to a nucleotide sequence that is at least partially complementary. The term “complementary” may also encompass duplexes that are fully complementary such that every nucleotide in one strand is complementary to every nucleotide in the other strand in corresponding positions. In certain cases, a nucleotide sequence may be partially complementary to a target, in which not all nucleotides are complementary to the corresponding nucleotides in the target nucleic acid.

The term “probe,” as used herein, refers to a nucleic acid that is complementary to a nucleotide sequence of interest. In certain cases, detection of a target analyte requires hybridization of a probe to a target. In certain embodiments, a probe may be immobilized on a surface of a substrate, where the substrate can have a variety of configurations, e.g., a sheet, bead, or other structure. In certain embodiments, a probe may be present on a surface of a planar support, e.g., in the form of an array.

An “array,” includes any two-dimensional and three-dimensional arrangement of addressable regions, e.g., spatially addressable regions or optically addressable regions, bearing nucleic acids, particularly oligonucleotides or synthetic mimetics thereof, and the like. In some cases, the addressable regions of the array may not be physically connected to one another, for example, a plurality of beads that are distinguishable by optical or other means may constitute an array. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a surface of the substrate. Depending upon the use, any or all of the arrays may be the same or different from one another and each may contain multiple spots or features. An array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μm², or even smaller. For example, features may have widths (that is, diameter, for a round spot) in the range from a 5 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 mm and less than 1.5 mm, such as more than about 0.8 mm and less than about 1.2 mm.

Arrays can be fabricated using drop deposition from pulse-jets of either precursor units (such as nucleotide or amino acid monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. Patent Application Publication No. 20040203138 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

Arrays may also be made by distributing pre-synthesized nucleic acids linked to beads, also termed microspheres, onto a solid support. In certain embodiments, unique optical signatures are incorporated into the beads, e.g. fluorescent dyes, that could be used to identify the chemical functionality on any particular bead. Since the beads are first coded with an optical signature, the array may be decoded later, such that correlation of the location of an individual site on the array with the probe at that particular site may be made after the array has been made. Such methods are described in detail in, for example, U.S. Pat. No. 6,355,431, 7,033,754, and 7,060,431.

An array is “addressable” when it has multiple regions of different moieties (e.g., different oligonucleotide sequences) such that a region (i.e., a “feature” or “spot” of the array) at a particular predetermined location (i.e., an “address”) on the array contains a particular sequence. Array features are typically, but need not be, separated by intervening spaces. An array is also “addressable” if the features of the array each have an optically detectable signature that identifies the moiety present at that feature. An array is also “addressable” if the features of the array each have a signature, which is detectable by non-optical means, that identifies the moiety present at that feature.

The terms “determining”, “measuring”, “evaluating”, “assessing”, “analyzing”, and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The term “using” has its conventional meaning, and, as such, means employing, e.g., putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier. The term “hybridization conditions” as used herein refers to hybridization conditions that are optimized to anneal an oligonucleotide of a sufficient length to a probe, e.g. an oligonucleotide that is not nicked and has a contiguous length of at least 20 nucleotides (e.g. at least 30, at least 40, up to at least 50 or more) complementary to a nucleotide sequence of the probe. Hybridization conditions may provide for dissociation of duplexes that anneal over a short length of region (e.g. less than 50, less than 40, less than 30, or less than 20 contiguous nucleotides) but not dissociation of duplexes formed between an un-nicked strand and its respective probe. Such conditions may differ from one experiment to the next depending on the length and the nucleotide content of the complementary region. In certain cases, the temperature for low-stringency hybridization is 5°-10° C. lower than the calculated Tₘ of the resulting duplex under the conditions used. Details on the hybridization conditions suitable for use in certain embodiments in the present disclosure may be found in U.S. Patent Publication 20090035762, the disclosure of which is incorporated herein by reference.

As used herein, the term “data” refers to a collection of organized information, generally derived from results of experiments in lab or in silico, other data available to one of skilled in the art, or a set of premises. Data may be in the form of numbers, words, annotations, or images, as measurements or observations of a set of variables. Data can be stored in various forms of electronic media as well as obtained from auxiliary databases.

As used herein, the term “plurality” refers to at least 2, e.g., at least 5, at least 10, at least 20, at least 50, at least 100, at least 500, at least 1,000, at least 5,000 or at least 10,000 or more, up to 50,000, or 100,000 or more.

As used herein, the term “homozygous” denotes a genetic condition in which identical alleles reside at the same loci on homologous chromosomes.

As used herein, the term, “heterozygous” denotes a genetic condition in which different alleles reside at the same loci on homologous chromosomes.

As used herein, the term “diploid” refers to genomic regions that exist in a cell with a copy number of two, i.e., twice the haploid number. For example, a reference assembly of the human genome includes approximately 3×10⁹ base pairs of DNA organized into distinct chromosomes. The genome of a normal diploid somatic human cell consists of 22 pairs of autosomes (chromosomes 1 to 22) and either chromosomes X and Y (males) or a pair of X chromosomes (female) for a total of 46 chromosomes. In a typical diploid cell, the autosomes are diploid.

As used herein, the term “non-diploid” refers to genomic regions that exist in a cell with a copy number that is not two. Non-diploid regions may be generated by duplication of a chromosome, or by a rearrangement (e.g., duplication or translocation) of a subchromosomal region. A genome of a cancer cell may contain variable numbers of chromosomes and subchromosomal regions relative to normal cells.

As used herein, the term “euploid” refers to a cell having a normal number of structurally normal chromosomes. Euploid human females have 46 chromosomes (44 autosomes and two X chromosomes), and euploid bulls have 60 chromosomes (58 autosomes plus an X and a Y chromosome).

As used herein, the term “aneuploid” refers to a cell having less than or more than the normal diploid number of chromosomes, aneuploidy is a commonly observed type of cytogenetic abnormality in cancer cells. Aneuploidy refers to any deviation from euploidy, including conditions in which only some regions of a single chromosome are missing or added.

The two most commonly observed forms of aneuploidy are monosomy and trisomy. Monosomy is lack of one of a pair of chromosomes. An individual having only one chromosome 6 is said to have monosomy 6. A common monosomy seen in many species is X chromosome monosomy, also known as Turner's syndrome. Monosomy is most commonly lethal during prenatal development. Trisomy is having three chromosomes of a particular type. A common autosomal trisomy in humans is Down syndrome, or trisomy 21, in which a person has three instead of the normal two chromosome 21s. Trisomy is a specific instance of polysomy, a more general term that indicates having more than two of any given chromosome.

Another type of aneuploidy is triploidy. A triploid individual has, on average, three of every chromosome, that is, three haploid sets of chromosomes. A constitutively triploid human would have 69 chromosomes (3 haploid sets of 23). Production of triploids is relatively common and can occur by, for example, fertilization by two sperm. However, birth of a live triploid is rare and such individuals are quite abnormal. The rare triploids that survive for more than a few hours after birth are thought to be mosaics, having a large proportion of diploid cells. Tumors, however, are not infrequently triploid. In the case of tumors, which do not necessarily have equal numbers of different chromosomes or regions of chromosomes, “triploid” refers to a tumor whose modal copy number is three.

As used herein, the term “mosaic” refers to a sample containing parent cells as well as aneuploid daughter cells that arose from a single parent. All daughter clones in a mosaic sample will share the same alleles with the progenitor (except for rare de novo mutations), and if the parent cells are homozygous for an allele, so also will be the aneuploid daughters. This distinguishes mosaic samples from “chimeric” samples, originating by e.g. fusion of two fertilized eggs.

The “aneuploid fraction” of a mosaic sample is the fraction of cells in the sample that are aneuploid.

As used herein, the term “single nucleotide polymorphism”, or “SNP” for short, refers to a phenomenon in which two or more alternative alleles (i.e., different nucleotides) are present at a single nucleotide position in a genomic sequence at appreciable frequency (e.g., often 1%) in a population. In some cases, SNPs may be present at a frequency less than 1% in a population. As used herein, the term SNP may include these “rare SNPs” (present at a frequency less than 1% in a population) or even “single nucleotide variants” (SNVs) that have only been detected in one or a few samples to date.

As used herein, the term “SNP site” denotes the position of a SNP in a genomic sequence. A SNP site may be indicated by genomic coordinates. The nucleotide sequences of hundreds of thousands of SNPs from humans, other mammals (e.g., mice), and a variety of different plants (e.g., corn, rice and soybean), are known (see, e.g., Riva et al 2004, A SNP-centric database for the investigation of the human genome BMC Bioinformatics 5:33; McCarthy et al 2000 The use of single-nucleotide polymorphism maps in pharmacogenomics Nat Biotechnology 18:505-8) and are available in public databases (e.g., NCBI's online dbSNP database, and the online database of the International HapMap Project; see also Teufel et al 2006 Current bioinformatics tools in genomic biomedical research Int. J. Mol. Med. 17:967-73).

As used herein, the term “SNP allele” refers to the identity of the nucleotide at a SNP site (e.g., whether the SNP site has a G, A, T or C). A “first allele” and a “second allele” of a SNP are different alleles, i.e., they have different nucleotides at the SNP site.

As used herein, the term “allele-specific copy number” indicates the number of copies of a particular SNP allele in a cell of a sample. For example, in many cases a SNP site of single chromosome can be occupied by either the first allele or the second allele of the SNP. In a diploid genome that SNP site can be: a) homozygous for the first allele of the SNP (in which case the allele-specific copy number of the first allele of the SNP is “2” and the allele-specific copy number of the second allele of the SNP is “0”), b) heterozygous (in which case the allele-specific copy number of the first allele of the SNP is “1” and the allele-specific copy number of the second allele of the SNP is also “1”), or c) homozygous for the second allele of the SNP (in which case the allele-specific copy number of the first allele of the SNP is “0” and the allele-specific copy number of the second allele of the SNP is “2”). In non-diploid regions, the copy number of a SNP allele may in be certain cases greater than 2. In case of a SNP that is present in a region with a copy number of four, the copy number of a SNP allele in that region can be 0, 1, 2, 3 or 4.

The term “chromosomal aberration” refers to a difference between the chromosomes of a test sample and a reference sample. Examples of chromosome aberrations include chromosomal rearrangements, e.g., inversions, translocations, duplications, deletions and insertions, etc.

The term “loss of heterozygosity” or “LOH” for short, indicates that a region of a test genome has lost heterozygosity relative to a parent genome or to a diploid reference genome. Loss of heterozygosity may be caused by several biological mechanisms, including, but not limited to, deletion of one copy of a region of a diploid chromosome, or UniParental Disomy (UPD) which can occur by trisomy within a fertilized egg, followed by loss of one copy of the chromosome, known as “trisomy rescue”. In cancer tumors, LOH is frequently caused by a somatic chromosomal rearrangement.

The term “copy number neutral loss of heterozygosity” refers to a region of a test genome that lacks heterozygosity but whose copy number is the same as a diploid reference genome. Copy number neutral LOH can occur when both copies of a genomic region in a diploid genome are contributed by a single parent, by parental consanguinity, or by a gene conversion event in which a locus in a first chromosomes of homologous chromosomes is replaced by the same locus in the second chromosome of the pair, leaving two copies of the second locus. Copy number neutral loss of heterozygosity is also known as uniparental disomy or acquired uniparental disomy. Copy number neutral loss of heterozygosity is common in both hematologic and solid tumors, and is thought to constitute 20 to 80% of the loss of heterozygosity observed in human tumors. Copy-neutral LOH cannot be detected by traditional CGH, FISH, or cytogenetics methods. A region that has lost heterozygosity can be identified as such because all the SNPs in the region are homozygous (i.e., from one parent or the other) rather than heterozygous.

Copy number neutral loss of heterozygosity is further described in Mao et al (Curr Genomics. 2007 8: 219-28), Gondek et al (Blood 2008 111: 1534-42); Beroukhim et al (PLoS Comput. Biol. 2006 2:e41); Ishikawa et al (Biochem. Biophys. Res. Commun.) 2005 333:1309-14) and Lo et al (Genes Chrom. Cancer. 2008 47: 221-37). The term “data” refers to both raw data and processed data. Raw data may be processed, e.g., normalized, smoothed, filtered, etc., prior to use in the subject method using any suitable method (see, e.g., Quackenbush, Nat. Gen. 2002 Supp. 32, van Houte et al BMC Genomics. 2009;10:401 and Staaf et al BMC Genomics. 2007 8:382, Staaf et al BMC Bioinformatics. 2008 9:409, Rigaill et al Bioinformatics. 2008 24:768-74, Curry et al Normalization of Array CGH Data In Methods in Microarray Pages 233-244

Normalization CRC Press 2008; incorporated by reference for all data processing steps, among many others).

The term “SNP data” refers to data obtained from an assay in which the SNPs of a test sample is analyzed relative to a reference sample in order to determined which SNP alleles are present in the test sample. Such an assay may be done by a wide variety of methods, including those of US20090035762, Mei et al (Genome Res. 2000 10: 1126-37) or Gunderson et al (Nat Genet. 2005 37:549-54), for example. In one embodiment, the assay may be done by sequencing a sample. In one embodiment, the assays involve comparing the level of hybridization of a test sample to a SNP-discriminating oligonucleotide relative to the level of hybridization of a reference sample to the same oligonucleotide. The ratio of hybridization indicates the relative numbers of copies of one of the SNP alleles present in the sample and the reference. With respect to SNP data, the term “ratio” refers to a value that indicates the to the allele-specific copy number of a SNP. The term “ratio” includes functions or transformations of a ratio, such as a log of a ratio.

With reference to the SNP data, the term “log₂ ratio” indicates the log base two of the ratio of the amount of hybridization of a test sample to a SNP-discriminating oligonucleotide relative to the amount of hybridization of the oligonucleotide to a reference sample.

The terms “CGH data” and “comparative genomic hybridization data” refers to data obtained from an assay in which the relative copy number of the same locus in two samples (e.g., a test sample and a reference sample) is determined. The general principles of a CGH assay are described in Barrett et al (Proc Natl Acad Sci 2004 101:17765-70) and Hostetter et al (Nucleic Acids Res. 2010 38: e9), for example. Such assays involve comparing the level of hybridization of a test sample to an oligonucleotide relative to the level of hybridization of a reference sample to the same oligonucleotide. The ratio of hybridization indicates the relative copy numbers of a sequence in the sample.

With reference to the CGH data, the term “log₂ ratio” indicates the log base two of the ratio of the amount of hybridization of a test sample to an oligonucleotide relative to the amount of hybridization of the oligonucleotide to a reference sample.

The term “diploid regions of a test and reference genome” refers to the regions of a test genome and a reference genome that are diploid. In any single assay, the reference genome may be diploid or partially diploid. Independently, the test genome may be diploid or partially diploid. In particular cases, the test genome and the reference genome are both diploid, in which case the diploid regions of the test and reference genomes include the entire genome (excluding any sex chromosomes). In other cases, the reference genome is diploid and the test genome is partially diploid and partially non-diploid. The ploidy of a genomic region can be determined by CGH, although a variety of other methods, e.g., FISH or sequencing, can also be employed. In one exemplary embodiment, a reference genome and/or test genome may be known a priori to be diploid and need not be tested to confirm that it is diploid.

The term “probability distribution function” is a continuous probability density function that identifies the probability of a value falling within a particular interval. A probability distribution clusters around a single mean value and describes the range of possible values that a random variable can attain and the probability that the value of the random variable is within any measurable subset of that range. Probability distribution functions include normal (i.e., Gaussian) distributions, although other distributions may be used. Methods for plotting a probability distribution function for data that forms a normal distribution are known. The probability that a hypothesis is true can be estimated using, e.g., Bayes' theorem, although other methods are known.

The term “confidence” refers to calculated estimate of the reliability of a determination. Confidence can be measured in any suitable way, e.g., using Bayes' theorem and expressed using, e.g., a p-value or a percentage or the like.

### DESCRIPTION OF EXEMPLARY EMBODIMENTS

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

A method of estimating the allele-specific copy number of a SNP in a test genome is provided. In certain embodiments, the method involves: a) calculating a plurality of probability distribution functions that fit a plurality of log₂ ratios indicating which alleles of a plurality of single nucleotide polymorphisms (SNPs) are present in diploid regions of a test and reference genome; and b) estimating the allele-specific copy number of a SNP of the test genome using said plurality of probability distribution functions.

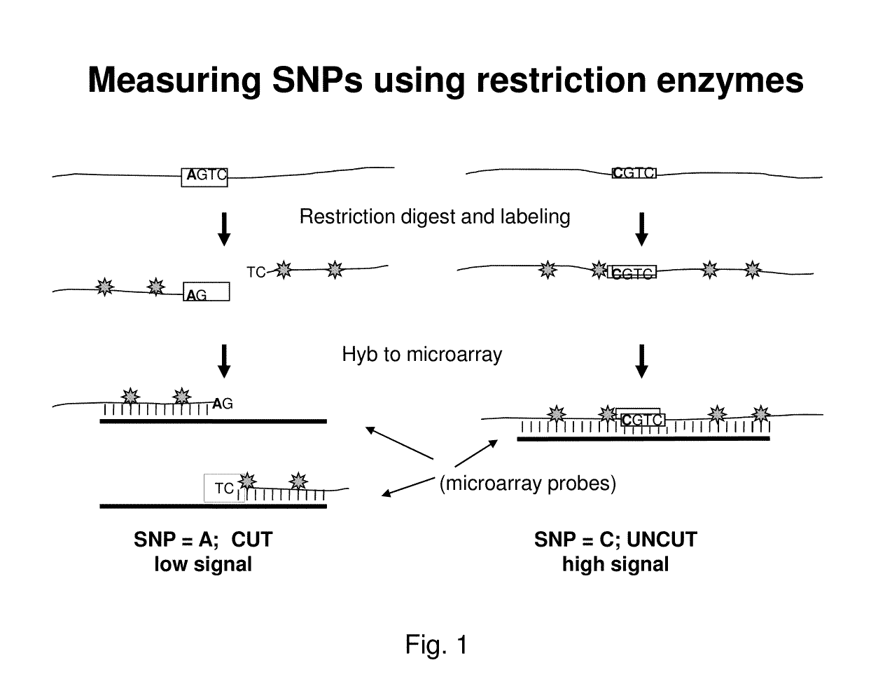

Certain embodiments of the subject method employ data indicating which SNP alleles are present in a sample. In general terms, the data is made up of ratios that indicate the amount of hybridization of a test genome to a SNP-discriminatory probe relative to the amount of hybridization of a reference genome to a SNP-discriminatory probe. If there is more of a particular SNP allele in the sample, then there is predictably either more or less hybridization, depending on the details of the assay. When used to analyze a diploid test genome relative to a diploid reference genome, the assay provides a ratio indicating that a particular allele of each single SNP has a copy number of 0, 1 or 2. The assay may provide data for a significant number of distinct SNPs, e.g., at least 100 SNPs (e.g., at least 500, at least 1,000 or at least 5,000 or more SNPs) in a genome in order to provide statistical significant results. Such an assay may be done by a wide variety of methods, including those of U.S.20090035762, Mei et al (Genome Res. 2000 10: 1126-37) or Gunderson et al (Nat Genet. 2005 37:549-54), The principles of the method described in U.S.20090035762 are generally described in FIG. 1. U.S. Patent Application Pub. No. 20090035762 is incorporated herein for disclosure of the details of this method, including exemplary probe design protocols, sample preparation protocols, sample labeling protocols, and data analysis protocols. FIG. 1 generally provides a SNP analysis method that comprises: a) contacting a first DNA sample comprising genomic DNA with a first restriction enzyme to provide a digested sample, wherein: i) the DNA sample may comprise a sequence comprising a SNP site;

and ii) the first restriction enzyme cleaves the sequence only if a first allele of a SNP is present at the SNP site; b) hybridizing the digested sample to a microarray comprising a probe sequence that is complementary to the sequence comprising the cleavage site; c) comparing the amount of hybridization between the digested sample and the probe sequence to the amount of hybridization between a reference sample and the probe sequence, and d) determining whether the first allele of the SNP is present in the DNA sample, wherein the relative hybridization of the digested sample to the probe as compared to the reference sample indicates whether the first allele of the SNP is present in the DNA sample. As illustrated, cleavage of the sequence at the cleavage site by the first restriction enzyme results in less hybridization of the digested sample relative to a sample in which the sequence is undigested.

In these embodiments, the terms “number of uncut copies” or “uncut copy number” both refer to the number of copies of a genomic allele that are not digested by a restriction enzyme. Analogously, the term “cut copy number” refers to the number of alleles that are digested by the restriction enzyme. Uncut copies are detected directly whereas cut copies are inferred at sites for which the total genomic copy number is known from CGH information.

In certain embodiments and as noted above, the subject method may further include measuring copy numbers of specific nucleotide sequences in combination with identifying SNPs as discussed above. In certain cases, the analysis of copy number may also be carried out using the same array, where the hybridization signals of a sample are also used to calculate copy number of sequences in the genomic sample. Additional features may be optionally included on the array to facilitate the analysis. Methods and composition used for assessing copy numbers are described in detail in U.S. Patent Application Pub. Nos. 20070238106 and 20070238108, disclosures of which are incorporated herein by reference.

As noted previously, the subject method involves the digestion of a double-stranded DNA in a genomic sample. The genomic DNA may undergo staining, shearing, fragmentations, amplification, purification, etc., prior to being contacted with the restriction enzyme in the method. The labeling step may incorporate a detectable label into a nucleic acid so hybridization to an array of probes may be measured. Detectable labels are known in the art and need not described in detail herein. Briefly, exemplary detectable components include radioactive isotopes, fluorophores, fluorescence quenchers, affinity tags, e.g. biotin, crosslinking agents, chromophores, colloidal gold particles, beads, quantum dots, etc. In certain embodiments, the detectable label, such as biotin, may require incubation with a recognition element, such as streptavidin, or with secondary antibodies to yield detectable signals. In other embodiments, the detectable label, such as a fluorophore, may be detected directly without performing additional steps.

In certain cases, the DNA under study may be stained with a nonspecific label, such as an intercalating fluorescent dye or other dyes that would label DNA in a non-sequence specific manner (e.g. DAPI, Hoechst, YOYO-1, YO-PRO-1, or PicoGreen).

The labeled samples may be hybridized to a suitable array, e.g., an array containing SNP spanning probes as described in U.S. Patent Application Pub. No. 20090035762 and, optionally, probes for determining copy number. In certain embodiments, the probes are designed such that duplexes formed by hybridization to the probes are Tₘ-matched. In some embodiments, the array contains duplicates of probes. In some embodiments, the array may contain multiple sets (e.g., at least 10, at least 100, at least 1,000, at least 10,000 or at least 50,000 or more sets) of probes, where each set of probes is designed for analysis of a single SNP site and may contain as few as two and as many as 4 or 8 probes. A simple example of a set of probes which has two members that detect the same SNP, is a set for which the sequence of a first probe is the complement of the sequence of a second probe.

Reading of the array may be accomplished by illuminating the array and reading the location and intensity of resulting fluorescence at each feature of the array to detect any binding complexes on the surface of the array. For example, a scanner may be used for this purpose that is similar to the AGILENT MICROARRAY SCANNER available from Agilent Technologies, Palo Alto, Calif. Other suitable apparatus and methods are described in U.S. Pat. No. 7,205,553 “Reading Multi-Featured Arrays” by Dorsel et al.; and U.S. Pat. No. 7,531,303 “Interrogating Multi-Featured Arrays” by Dorsel et al., both disclosures of which are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

As noted above, the subject method involves comparing the data derived from a genomic DNA sample to a reference. The reference may also undergo the subject method in the same way as the genomic sample under interest. In other cases, the reference sample is contacted to an array to provide hybridization signals as a control. The reference sequence may be a sequence derived from an identified source or from the same species as the genomic sample under study. The source of the reference may be known to be homozygous or heterozygous for a particular genomic locus of interest. In certain cases, the source may be wild-type for a genomic locus of interest. The source may contain an allelic variant of interest. In certain cases, the reference sequence may be known so that the alleles of the single nucleotide polymorphisms are known.

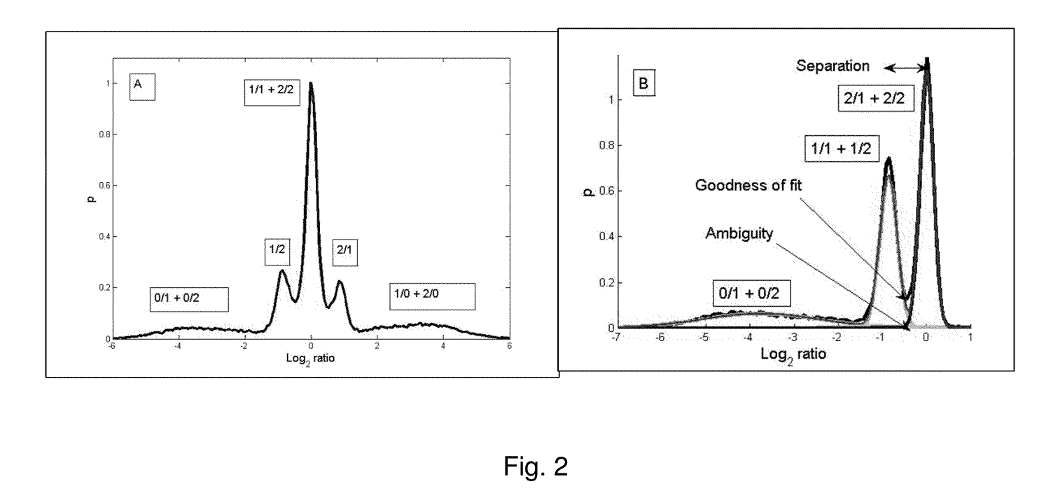

The log₂ of the ratio of signals obtained in the SNP assay and, optionally, the log₂ ratio of the signals obtained from the CGH assay are employed in the subject method. In general terms, the method comprises: a) calculating a plurality of probability distribution functions that fit a plurality of log₂ ratios indicating which alleles of a plurality of single nucleotide polymorphisms (SNPs) are present in diploid regions of a test and reference genome; and b) estimating the allele-specific copy number of a SNP of the test genome using the plurality of probability distribution functions. In one embodiment, the reference genome is of known genotype and is diploid everywhere, except on sex chromosomes. If the sample is also diploid, the measured SNP log ratios cluster into five peaks, corresponding to different sample/reference ratios of the uncut allele copy number. These five peaks are illustrated in FIG. 2A, which shows the distributions of log ratios of SNP probes in diploid regions, measured for a normal male versus a normal (diploid) female. Each peak corresponds to a different ratio of sample copy number to reference copy number of the measured uncut allele.

Since the reference genotype is known, the SNPs with zero reference copies are ignored, since the 1/0 and 2/0 contributions to the peaks of FIG. 2A cannot be reliably distinguished from the log ratios. In some embodiments, SNPs having one uncut copy in the reference sample can be fit to three distributions, corresponding to 0, 1, or 2 uncut copies in the test sample, and SNPs having two uncut copies in the reference sample can be independently fit to three different distributions. In the preferred embodiment, the data are adjusted by subtracting 1 from the log₂ ratios of SNPs with one reference copy to provide a set of reference adjusted log ratios that fall into three nearly Gaussian peaks corresponding to the copy number of the uncut alleles in the test sample. The result of applying this data transformation to the raw log ratios of FIG. 2A is illustrated in FIG. 2B.

As will be described in greater detail below, the probability distribution functions may be employed in several different ways to estimate the allele-specific copy number of a SNP of the test genome. In particular cases, the SNP whose uncut copy number will be estimated has data represented in the probability distribution functions, in which the allele specific copy number of the SNP can be readily determined by identifying which distribution the data for the SNP fits to. In other cases and as will be described in greater detail below, the probability distribution functions can be used in conjunction with other information to determine the allele-specific copy number of a SNP that is not represented in the probability distribution. In particular cases, the SNP may be in a diploid region of the test genome, or in a non-diploid region of the test genome.

The method may be employed to examine a genome that is entirely diploid (with the exception of sex chromosomes), or a genome that contains non-diploid regions. The SNP whose uncut copy number will be estimated may be in a diploid or non-diploid region of a genome. In particular embodiments, the test sample used to produce the log₂ ratios employed in the method may be mosaic, and the method may be employed to determine the allele specific copy number of a SNP in both diploid and non-diploid regions of a mosaic sample.

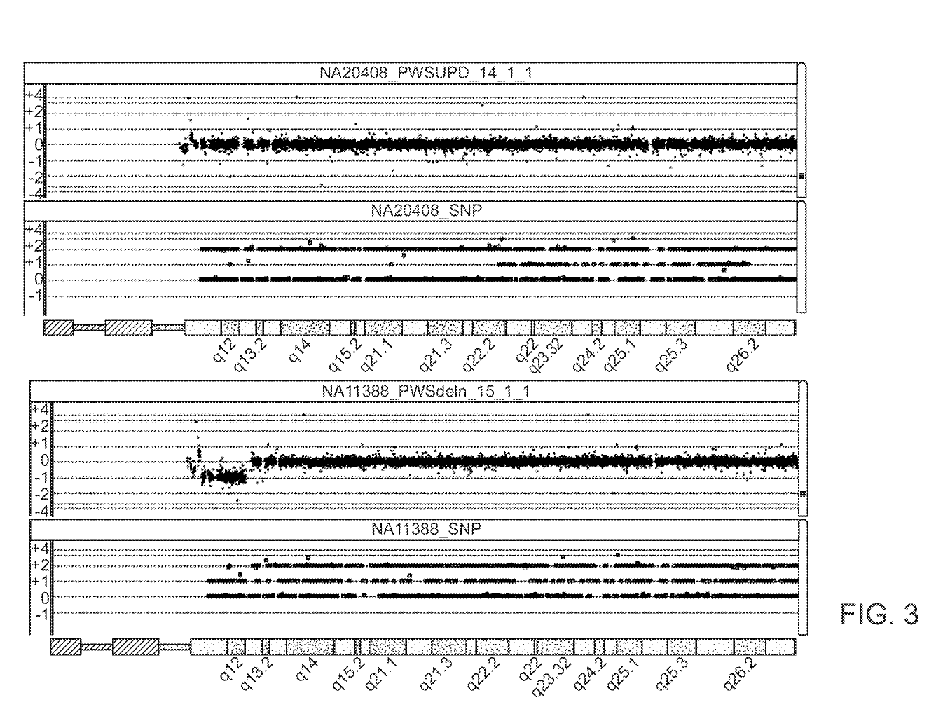

In particular cases, the method may further include comparing the test and reference genomes to obtain copy number data, i.e., “CGH data”. In these embodiments, the method may be used to identify a copy number neutral loss of heterozygosity (LOH) event in the genome, as illustrated in FIG. 3.

In a particular embodiment, the log ratios obtained from a SNP assay are first adjusted to account for the allele-specific copy numbers in the reference sample. SNP probes which do not hybridize in the reference report ratios with a denominator that is practically zero. These SNPs therefore cannot be called reliably from log ratios, although many of them can be estimated by analyzing the raw signal in the sample channel, as will be described in greater detail below. Ratios for probes for which the reference is heterozygous can be divided by two to put them on the same scale as SNPs for which the reference is uncut. After this reference correction, the log ratio distribution for a normal diploid sample shows three Gaussian peaks, corresponding to allele-specific copy number of zero, one, and two. FIG. 2 shows the distribution of raw and reference-corrected SNP log ratios for a typical normal (i.e. almost entirely diploid, except on sex chromosomes) sample. The distributions of log ratios are very nearly normal, and can be modeled to a good approximation by Gaussian distributions. The likelihood that each SNP site has a particular allele-specific copy number is then computed by applying Bayes' rule to the reference corrected log₂ ratios, using the fitted Gaussian distributions.

In certain cases, the method may further involve calculating a likelihood score indicating the confidence that the allele-specific copy number of the SNP has been correctly assigned, wherein the score is calculated using the plurality of probability distribution functions. In particular embodiments, the method may further include calculating an expectation value for the allele-specific copy number of a SNP.

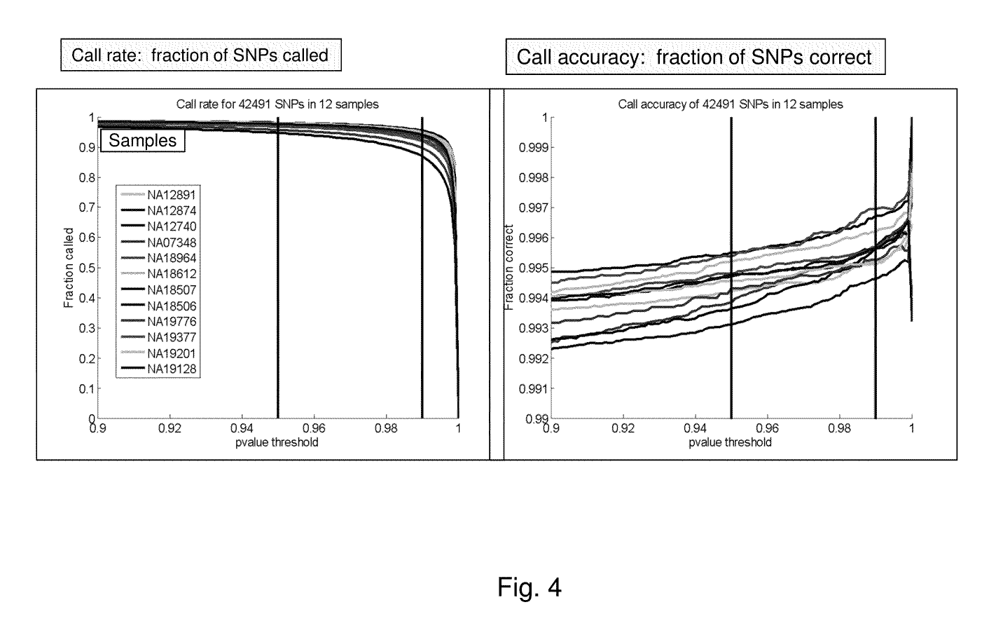

Because the log ratio distributions are well described by a Gaussian model, it's possible to compute the Bayesian likelihoods of the different uncut copy number states for each SNP. The genotype can be called at each SNP as the most likely state, with a confidence equal to the likelihood of that state. Typically, over 90% of SNPs are called with a likelihood>95%. These results can be visualized as an expectation value of the allele-specific copy number. FIG. 4 shows the fraction of 42,291 SNPs called in 12 samples and the fraction of SNPs correctly called in those samples, as a function of the confidence scores.

In particular embodiments, the method may involve estimating the allele-specific copy numbers for a plurality of SNPs to provide a dataset of allele-specific copy number estimates; and calculating likelihood scores for the allele-specific copy numbers indicating the confidence that the allele-specific copy numbers have been correctly assigned. The likelihood scores are calculated using the plurality of probability distribution functions. The genotype of the sample at these SNP sites is then inferred from the allele-specific copy number estimates and from the total copy number estimates derived from the surrounding CGH probes. The genotype is not reported for SNP sites whose likelihood scores are below a threshold, e.g., have a confidence value of less than 0.90, less than 0.92, less than 0.95, less than 0.98 or less than 0.99, etc.

As illustrated in FIG. 3, the method may further comprise comparing the test and reference genomes to obtain CGH data, and aligning the CGH data with the allele-specific copy number of a plurality of individual SNPs along a physical map to produce a genomic alignment. A chromosomal aberration, e.g., a copy number neutral loss of heterozygosity may be identified using such an alignment. In these embodiments, a genomic region containing an unexpectedly low fraction of heterozygous probes can be identified by a number of statistical methods, for example by assuming a binomial distribution of independent SNPs with the binomial p parameter estimated from the overall fraction of heterozygous SNPs in the genome.

For example, Prader-Willi syndrome is a genetic disorder caused by deletion or inactivation of genes on the paternally inherited copy of chromosome 15, while the maternal copy is imprinted and therefore silenced. By measuring SNPs simultaneously with copy number, we can distinguish variations in the underlying genetic origin of the disease caused by deletion or by uniparental disomy.

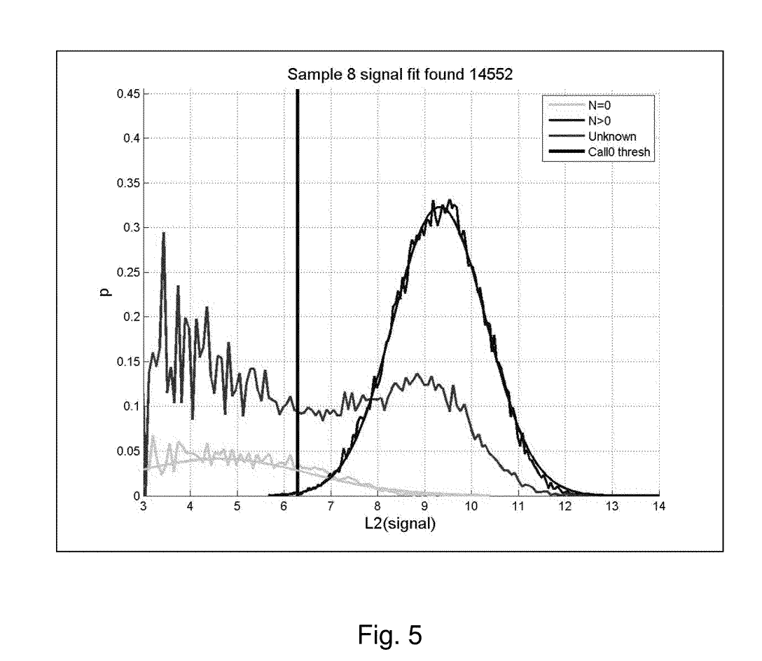

In addition, distributions of log₂ (signal) for SNPs with non-zero reference copy number can be used to determine the allele-specific copy number of a subset of SNPs with zero reference copy number, which otherwise cannot be assigned based on their log₂ ratios, as explained above. By comparing the log₂(signal) distributions, of SNPs called as AsCN 0 with the distributions for SNPs called as AsCN>0, the copy number of some SNPs reporting sufficiently low signals can be identified as true zero copy number (FIG. 5).

In another aspect, the method may comprise: a) subjecting a mosaic test sample to both CGH and SNP analysis to obtain: i. CGH data indicating which parts of a genome are diploid and which parts are non-diploid, ii. SNP data comprising log₂ ratios indicating the allele-specific copy number of a plurality of SNPs that are present in diploid regions, and iii. SNP data comprising log₂ ratios for a plurality of SNPs that are present in a non-diploid region of the genome; b) calculating the fraction of cells in the mosaic sample that are aneuploid using the CGH data; c) calculating probability distribution functions that fit the log₂ ratios of SNPs having AsCN's of 0, 1, and 2 in diploid regions; and d) estimating the allele-specific copy number of SNPs in the non-diploid regions of the test genome using i. the said probability distribution functions, ii. the said aneuploid fraction and iii. the log₂ ratios for SNPs that are present in the non-diploid regions of the genome.

In this aspect, the estimating may comprise: a) modeling a plurality of expected distribution functions using: i. the said probability distribution functions, and ii. the said aneuploid fraction; and b) fitting the log₂ ratios for SNPs that are present in each non-diploid region of the genome to the expected distribution functions in that region; and c) determining which of the expected distribution functions most closely matches the log₂ ratios for SNPs that are present in each non-diploid region of the genome.

Some features of this method include: (a) the assignment of AsCN likelihoods by region, rather than globally, where regions are delimited not by e.g. Hidden Markov Models run on SNP data, but by CGH copy number aberration calls, and (b) the method by which AsCN state probabilities are inferred in aberrant regions.

The current invention assigns allele-specific copy numbers derived from Bayesian likelihoods based on Gaussian probability distributions. That is, the model assumes that the observed log ratio of a SNP probe falls in a Gaussian distribution centered on the log ratio corresponding to the true allele-specific copy numbers of the targeted SNP site. This model has several virtues: first, it arises from a simple physical model of the sources of noise in the assay, second, it is very close to being true (typically less than 1% deviation between modeled and observed log ratios), third, it can easily be parameterized from internal evidence in the data from a single array, without requiring external calibration, and also it is relatively straightforward to compute. The ability to parameterize the model from internal evidence relies statistically on the thousands of SNPs which share the same possible underlying allele-specific copy numbers, in order to be able to stably fit

Gaussian distributions. In mosaic samples each genomic region may have a different mix of fractional allele-specific copy numbers, whose log ratios cannot simultaneously be fit to the same distributions. At the same time, many or most aberrant regions comprise too few SNPs to allow them to be robustly fit independently to Gaussian distributions. Thee globally similar noise distribution among probes in a single assay estimates probable Gaussian distributions of signals arising from AsCN states in regions that are too sparse to fit independently.

In most aneuploid samples there are a significant number of probes in diploid regions. Even in mosaic samples, such probes (unlike probes in non-diploid regions) can only have integral (zero, one, or two) copies of the measured allele. In samples with a sufficiency (i.e. thousands) of SNP probes in such regions, Gaussian distributions can be robustly fit. These distributions, fitted to log ratios in diploid regions, can then be used to predict probable log ratio distributions in non-diploid regions. Since the aneuploid fraction of the sample is known, the center of the Gaussian distribution corresponding to any (including fractional) AsCN can be reliably predicted. The array error model allows a robust prediction of the effect of shifts in the mean log ratio on the variance of the distribution. Finally, assumption 2 permits us to estimate (as described below) the relative proportions of the AsCNs in the overall distribution. Together these methods produce a reliable AsCN estimate in non-diploid regions which comprise too few probes to be reliably fitted independently.

In summary, certain embodiments of the method include: a) identifying copy-number variant regions as for CGH, b) determining the aneuploid fraction of the sample from CGH data and assigning a copy number to each aberrant region, and thence to each SNP probe; c) fitting allele specific copy number=0, 1, 2 Gaussians to SNP probes in diploid regions; and d) for each aberrant region, shifting and sometimes broadening the fitted Gaussians to generate estimates of the distributions of the up to four possible log₂ ratio distributions expected in that region. This model is based on the following assumptions: (1) The sample is a mosaic of (mostly) a single aberrant clone and a (mostly) diploid “parent” normal, (2) (almost) all alleles in the aberrant clone are present in the parent normal clone, and (3) the maternal and paternal counts are (usually) constant within each copy-number variant region.

In more detail, this method is based on the observation that in each aberrant region, the aberrant clone comprises m copies of one “parental” genome, and N−m copies of the other, with m<=N−m. The aberrant clone contributes a fraction of the cells f, with the remaining 1−f cells diploid normal (the minor complication introduced by chrX probes in males will be ignored here). By assumption, if the normal genotype is aa (doubly cut) at a SNP site, the aberrant clone will also be doubly cut, and the same for bb (doubly uncut). So we expect to see net AsCNs of 0 and fN+2(1−f) in the mixture. If the normal clone is heterozygous at a SNP site, the aberrant clone will contain m copies of one allele, and N−m copies of the other. So the observed net AsCN will be either fm+(1−f) or f(N−m)+(1−f), depending on whether the a or b allele contributes the most copies to the aberrant clone. Therefore we expect in general to see four different log ratio peaks in each region, corresponding to 0, fm+1−f, f(N−m)+1−f, and fN+2−2f copies of the uncut allele.

Both N and f are determined from the CGH copy number fits, and the positions, widths and relative intensities of the Gaussians corresponding to 0, 1, and 2 copies are known from the Gaussian fits in diploid regions. We generate theoretical Gaussians at the appropriate LR and intensity, and compute Bayesian likelihoods for each SNP in the aberrant region. These generated Gaussians are centered at the log ratio value expected from the mosaic model, are assigned widths based on a simple error model, and are given intensities proportional to the number of probes in the aberrant region. The only free parameter is the integer value of the allelic copy number m which is fitted independently for each aberration. In this way, very small aberrations can be genotyped.

In certain embodiments, a method of determining the genotype of aneuploid or mosaic samples by array hybridization of total genomic or amplified DNA is provided. The sample isolation, amplification, and labeling follow the same protocol(s) as CGH or cytogenetic CGH+SNP assays except that (a) the samples are referenced against an individual, genotyped reference sample, and (b) the DNA samples may be restriction digested using enzymes that cut at targeted SNP sites. As noted above, the method relies on three assumptions about the sample: a) the sample is a mosaic of (mostly) a single aberrant clone and a diploid “parent” normal, b) all alleles in the aberrant clone are present in the parent normal clones, and c) the maternal and paternal allelic counts are constant within each copy-number variant region. Violations of these three assumptions can usually be detected from internal consistency checks. In certain cases, the basic steps of some embodiments of the method include: A) find aberrant regions, as previously described for CGH arrays; B) Determine the ploidy and the aneuploid fraction of the sample from CGH data (see, e.g., Curry et al Normalization of Array CGH Data In

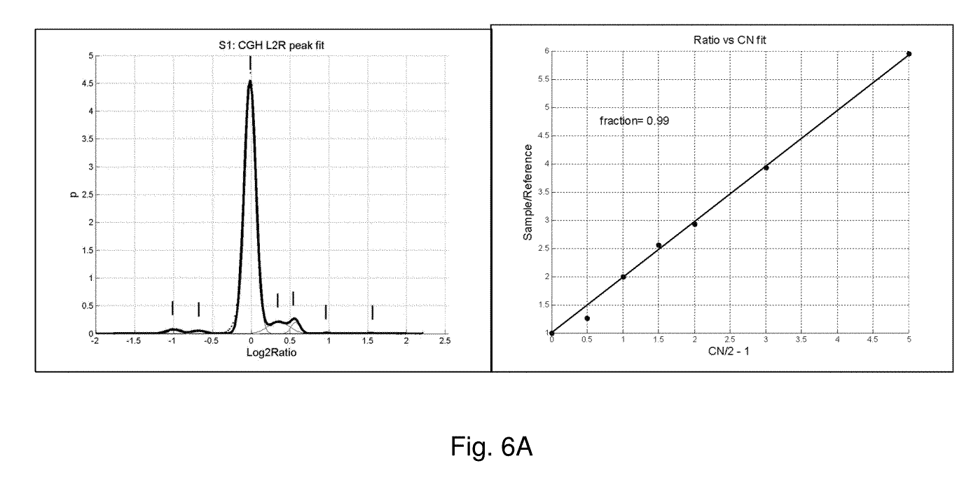

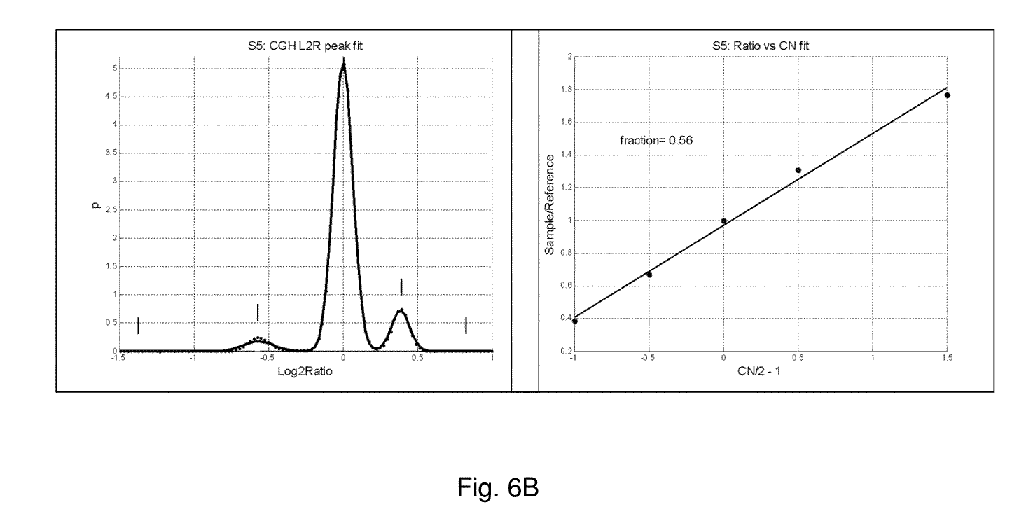

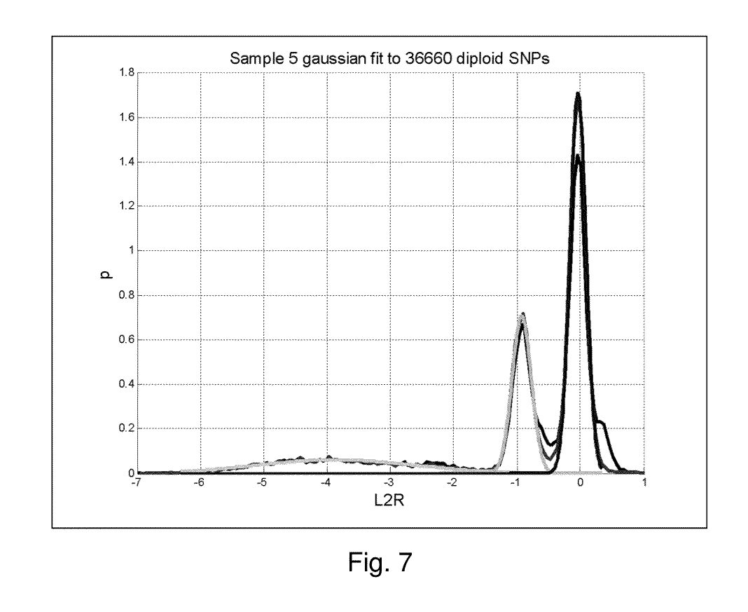

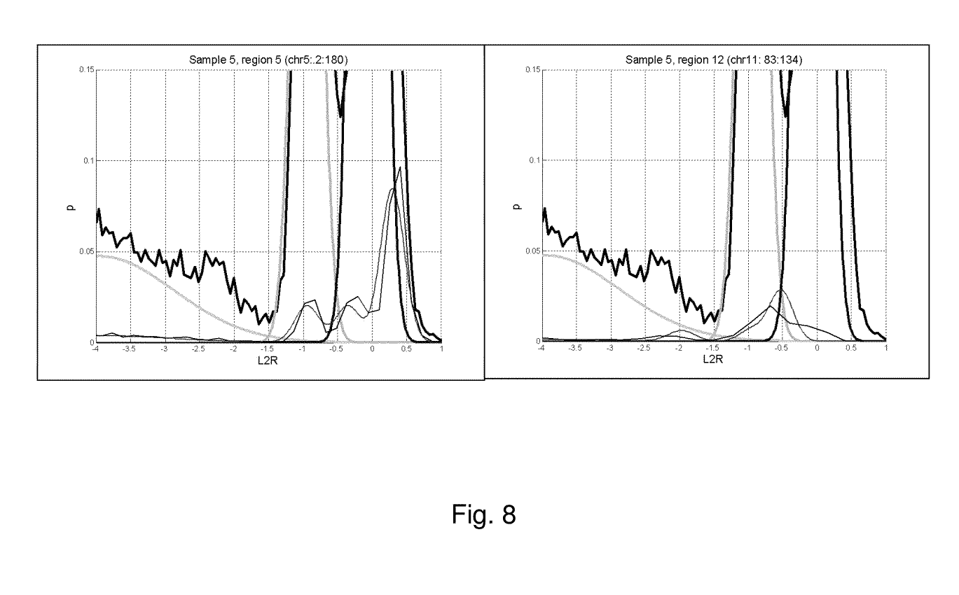

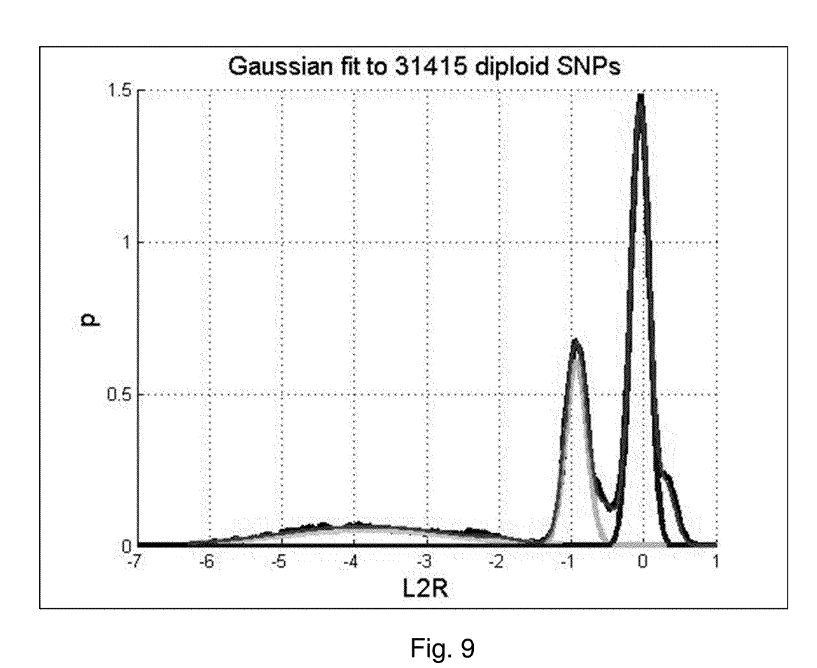

Methods in Microarray Pages 233-244 Normalization CRC Press 2008; incorporated by reference for all data processing steps) See FIGS. 6A and 6B. Assign a total copy number to each genomic region, aberrant or normal, and thence to each SNP probe within the region; C) Correct the observed LR of the SNP probes for the allele-specific copy number (AsCN) of the reference sample, as previously described for cytogenetic CGH+SNP arrays; D) Fit AsCN=0, 1, 2 Gaussian distributions to the reference-corrected SNP log₂ ratio distributions in diploid regions of the genome (FIG. 7); E) For each aberrant region of a mosaic sample, shift and possibly broaden the fitted Gaussians to model the estimated distributions of the up to four possible LRs expected in that region (testing assumption 3) (FIG. 8); F) In a mosaic sample, the total observed distribution should equal the sum of the regional distributions (FIG. 9). This tests assumption 1, above.

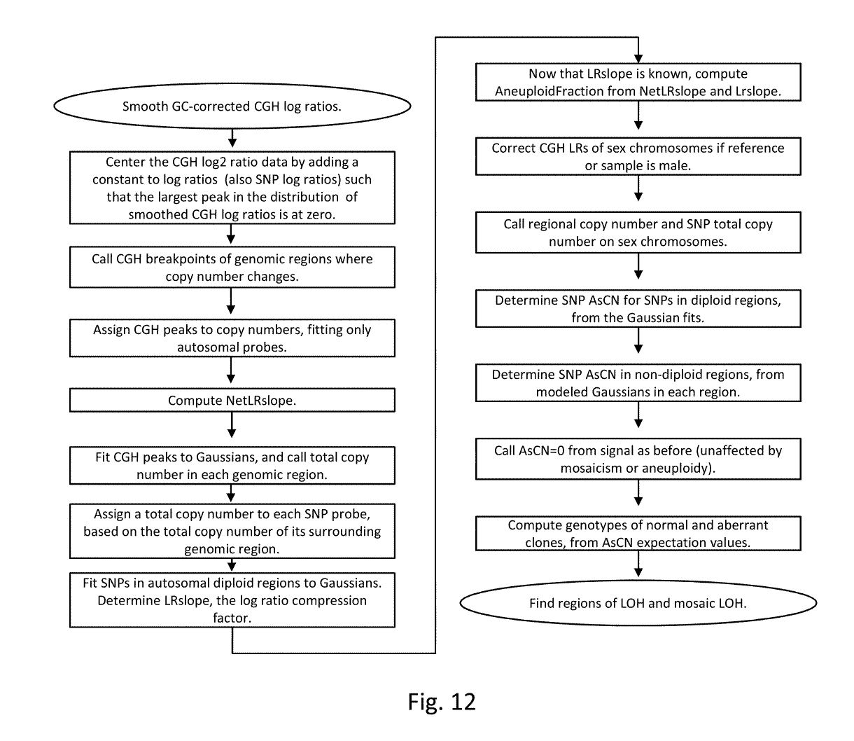

This analysis generates for each SNP both the genotype of the “parent” normal, and the genotype of the aberrant “daughter”. The combination of the two genotypes allows the computation of the haplotype throughout each unbalanced aberrant region. One exemplary implementation of this method is shown in FIG. 12.

In one embodiment, the method may implemented by a computer. A tangible computer-readable medium containing instructions (i.e. “programming”) for performing the method described above. The programming can be provided in a physical storage or transmission medium. A computer receiving the instructions can then execute the algorithm and/or process data obtained from the subject method. Examples of storage media that are computer-readable include floppy disks, magnetic tape, DVD, CD-ROM, a hard disk drive, a ROM or integrated circuit, a magneto-optical disk, or a computer readable card such as a PCMCIA card and the like, whether or not such devices are internal or external to the computer. A file containing information can be “stored” on computer readable medium, where “storing” means recording information such that it is accessible and retrievable at a later date by a computer on a local or remote network. In the context of a computer-implemented method, “obtaining” may be accessing a file that stores data.

### EXAMPLE

The exemplary assay described below uses the standard Agilent two-color CGH protocol, with enzymatic digestion and labeling (See, e.g., Barrett et al, supra). The DNA sample is digested with restriction endonucleases, and, after digestion, the fragmented targets are copied using a Klenow-fragment enzyme to incorporate fluorescently labeled nucleotides. A reference sample of known genotype is concurrently restricted and labeled with a different fluorescent tag. The sample and reference are cohybridized to a microarray containing up to a million CGH probes and tens of thousands of SNP probes. The arrays are then washed, and the signal ratios of the sample to the reference channel are measured and reported.

### Overview

The total copy number and aneuploid fraction are determined from the CGH probes. The genome is divided into diploid and aneuploid regions, based on the log ratios of the intensities of the CGH probes relative to the (diploid) reference sample. The total copy number of aberrant regions is determined from the average log ratio of each region.

The fraction of aneuploid cells in a mosaic sample can be computed from the slope of the log ratio vs copy number response curve, as previously reported (Curry et al Normalization of Array CGH Data In Methods in Microarray Pages 233-244 Normalization CRC Press 2008)

In addition to the CGH probes, several thousand SNP probes on the arrays target SNPs that modify alul and rsal cleavage sites. One variant allele is cut by the restriction digestion, and is not observed, while the other remains intact, and hybridizes efficiently to the array. The copy number of the uncut allele (allele-specific copy number, or AsCN) is determined from log ratio of the observed intensity of each SNP probe in the unknown sample, relative to that of the known reference sample.

In diploid regions of the genome, three peaks are expected in the log₂ ratio distributions of SNP probes after reference correction. These peaks correspond to homozygous doubly-cut (AsCN=0), heterozygous singly-cut (AsCN=1), and homozygous uncut (AsCN=2). However, in some regions only two peaks are observed (AsCN=0 and 2) due to loss of heterozygosity (LOH) throughout the interval. In mosaic samples, we might also observe regions having four peaks (AsCN=0, 1−f, 1+f, and 2), due to LOH in a fraction (f) of aberrant cells. These regions are detected by observing an unusual broadening or splitting of the AsCN=1 peak.

In non-diploid regions of an aneuploid sample, the net log₂ ratios observed for SNP probes in a mixture of aberrant and normal clones will appear at values corresponding to fractional AsCN, and in general at different fractional values in different aberrant regions. In this circumstance, SNP log ratios cannot be fit to a global distribution, but must be determined separately in different aberrant regions. A strong model of the underlying biology is used to compute AsCNs in aberrant regions in a numerically robust manner.

Once AsCNs have been assigned to all SNP sites, regions of constitutive and acquired LOH can be detected by looking for regions with a statistically significant dearth of heterozygous SNP sites. The algorithms used to estimate total copy number, allele-specific copy number, and LOH regions in mosaic aneuploid samples are described below.

### Reference Requirements

Since the precision of the method depends upon measuring the ratio of the signal from a test sample to that from a reference sample, it is often necessary to hybridize each sample against an individual reference sample whose genotype is known a priori. Both the genotype and the total copy number of the reference should be known at each SNP and CGH probe site. In practice, small copy number variant (CNV) regions in the reference will appear as false positive aberration calls in the sample, and SNP sites which are incorrectly called in the reference are likely to be also miscalled in the samples. In the HapMap II (e.g., The International HapMap Consortium. Integrating common and rare genetic variation in diverse human populations. Nature 467, 52-58. 2010) reference samples, whole genome sequencing has suggested about a 0.1% error rate in the published genotypes, which agrees with experimental observations (not shown). In locally genotyped references, this error rate may be higher or lower. It is recommended that the reference DNA be extracted using the same protocol and if possible the same laboratory as the sample DNA, and preferably restricted and labeled concurrently.

### Total Copy Number and Aneuploid Fraction

The total copy number and aneuploid fraction are determined from the CGH probes alone. The CGH log ratios are smoothed to reduce the noise level, and the distribution of smoothed log ratios is plotted (FIG. 6). Ideally, the log ratio distribution exhibits one or more well-separated peaks, each of which corresponds to a distinct integral copy number of one or more regions of the test sample. The log ratios of these peaks are determined using a peak-picking algorithm. The most intense peak is tentatively assigned a copy number of two, and other peaks are assigned copy numbers conformant to a linear relationship between copy number and observed ratio (FIG. 6). A good line fit indicates that the copy number differences between regions giving rise to the peaks have been correctly assigned.

In general, the absolute copy number corresponding to each of the log ratio peaks cannot be definitively determined from the aCGH data alone. For example, a consistently tetraploid cell line such as Raji is difficult to distinguish from a diploid sample. If the experimenter has prior knowledge of the true copy number of any genomic region, e.g. from FISH or SKY data, then the copy numbers of the CGH peaks can be confidently assigned. Even if no independent information is available, however, some simple heuristics can be used to choose the most likely sample ploidy in most practical cases: A) The line slope of a fitted plot of ratio vs. copy number must be<=1.0. Typical log ratio compression in the Agilent assay is 0.85-0.95, resulting in a slope of 0.89-0.96 for a monoclonal sample. Mixtures of aberrant with normal diploid cells will have smaller slopes, but larger slopes aren't possible. B) Any large peak (>=60% of maximum) is not less than diploid. C) At most one medium peak (>=20%) can be less than diploid. Sample genomes, however aberrant, are unlikely to be viable if they have fewer than two copies of most genes. D) No region has CN<0. The correctness of the assignment of the diploid regions can also be assessed from the goodness of fit of the SNP log ratios in presumed diploid regions. If the total copy number assignment is not correct, the SNP log ratios are unlikely to fit well to three distinct peaks.

### Limits of the Model

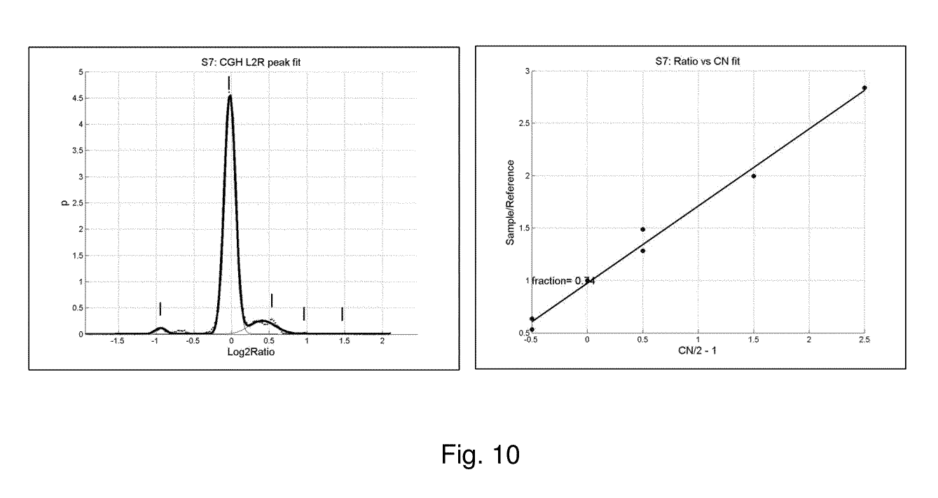

The primary assumption of the model underlying the total copy number algorithm is that the sample is a mixture of at most one aberrant clone and matched normal cells. Many tumors, perhaps even the majority of solid tumors, violate this assumption to some degree. This situation manifests itself as doubled peaks, or shoulders on peaks, as seen in FIG. 10. In mild cases the secondary aberrant clones will be of low abundance (broadening of peaks in the distribution, rather than splitting them), or nearly identical to the primary aberrant clone (only differing in a few regions). In these cases, the data analysis described here will succeed in most genomic regions, and regions with differing copy number in different clones will be identified, though probably not successfully analyzed. In more severe cases the methods described here will fail.

### Reference-correction of SNP Log Ratios

FIG. 2 shows the distribution of raw and reference-corrected SNP log ratios for a typical normal sample using methods that are described above. The distributions of log ratios are very nearly normal, and can modeled to a good approximation by Gaussian distributions. The likelihood that each SNP site has a particular AsCN is then computed by applying Bayes' rule to the observed reference-corrected log ratio of the probe to that SNP, and the fitted Gaussian distributions.

### The Mosaic Model

As described above, a “mosaic” sample is a sample containing multiple clones, all of which arose from a single progenitor, without de novo substitutions. Hence all clones in a mosaic sample will share the same alleles, and if the “parent” normal tissue was homozygous, so also will be its aneuploid “daughters”. This distinguishes mosaic samples from “chimeric” samples, originating by fusion of two fertilized eggs, meiotic nondisjunction events, or other polyclonal samples, which are not included in our model.

In the subject mosaic model, the genome is divided into regions, for each of which we determine the total copy number from the CGH data as described above. In each autosomal region i, there are Nᵢ copies in the aberrant clone with 2 copies supplied by the normal fraction. Sex chromosomes of male samples are handled similarly, except that the normal fraction supplies only a single copy. We know the fraction f of aberrant cells from the CGH copy number fit. In each region, the Nᵢ copies of the aberrant clone consist of mᵢ copies of one parental chromosome, and Nᵢ−mᵢ copies of the other, where mᵢ is an integer less than or equal to Nᵢ/2. A SNP which was homozygous cut in the parent normal clone will necessarily also be cut in the aberrant clone, and will therefore report a log ratio consistent with AsCN=0. Similarly, a SNP which was homozygous uncut in the parent normal clone will necessarily also be uncut in the aberrant clone, and will therefore report a log ratio consistent with AsCN=totalCN=Nᵢ*f+2*(1−f). SNPs heterozygous in the parent clone will have either mᵢ, or Nᵢ−mᵢ copies in the aberrant clone. The central peak of the normal SNP log ratio (LR) distribution of FIG. 2 will either disappear completely, remain at LR˜−1, or split into two separate peaks, according to whether mᵢ=0, Nᵢ/2, or something else. These cases correspond to LOH, balanced amplification, or unbalanced deletion or amplification, respectively.

This simple model of the cancer genotype is satisfied in most if not all regions in many blood and solid tumors. Samples or smaller regions in samples which violate the assumptions of the model, either because they include multiple aberrant clones, or because the clones are not related by descent, can readily be detected and flagged for more comprehensive investigation.

### Fit AsCN by Region

The mosaic model predicts there to be between one and four separate peaks in the SNP log ratio distributions in each aberrant region. Many aberrant regions contain too few SNP probes to permit a stable Gaussian fit to peaks in the region. However, the Gaussian distributions expected in each region can be predicted from the three Gaussian peaks fitted in diploid regions, the total copy number in the region, and the aneuploid fraction. Since Nᵢ is computed for each aberrant interval from the CGH probes, the only parameter which must be independently fit in each aberrant region is the integer value of mᵢ in the region.

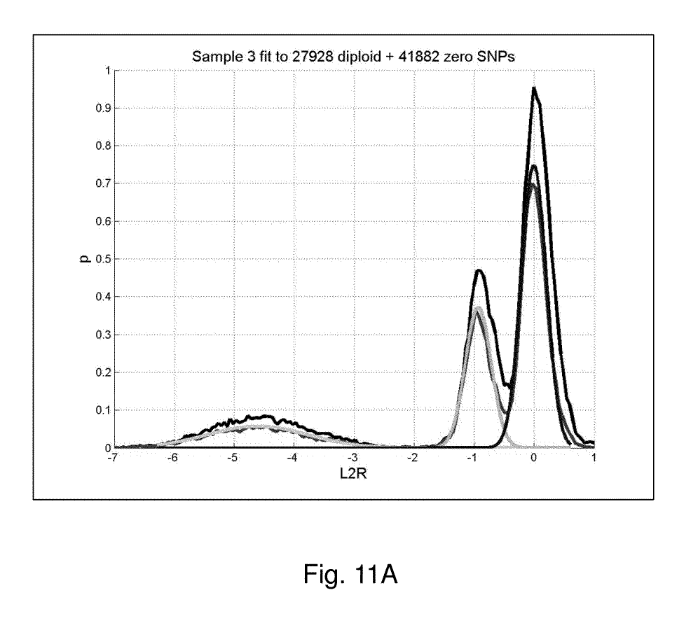

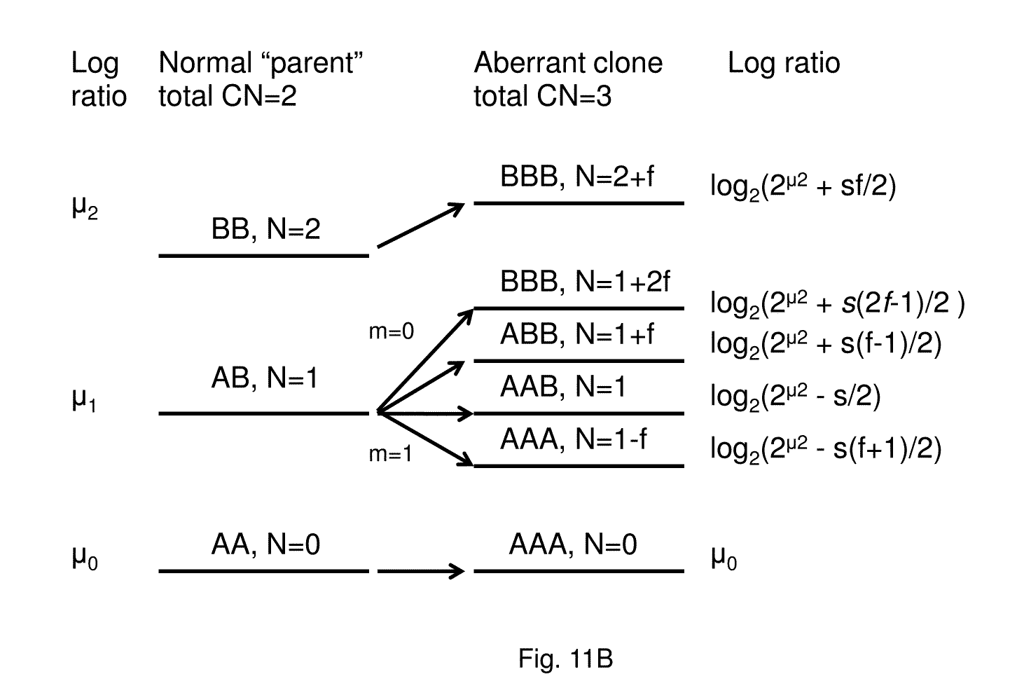

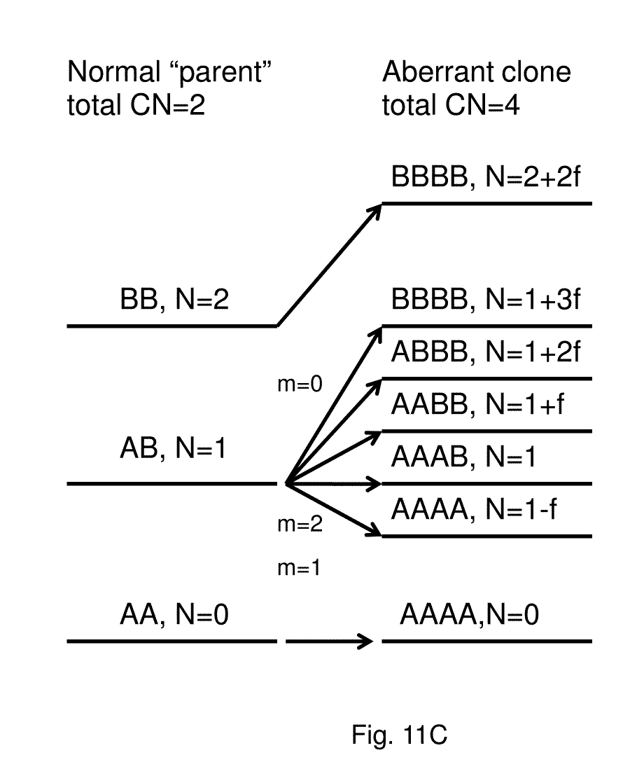

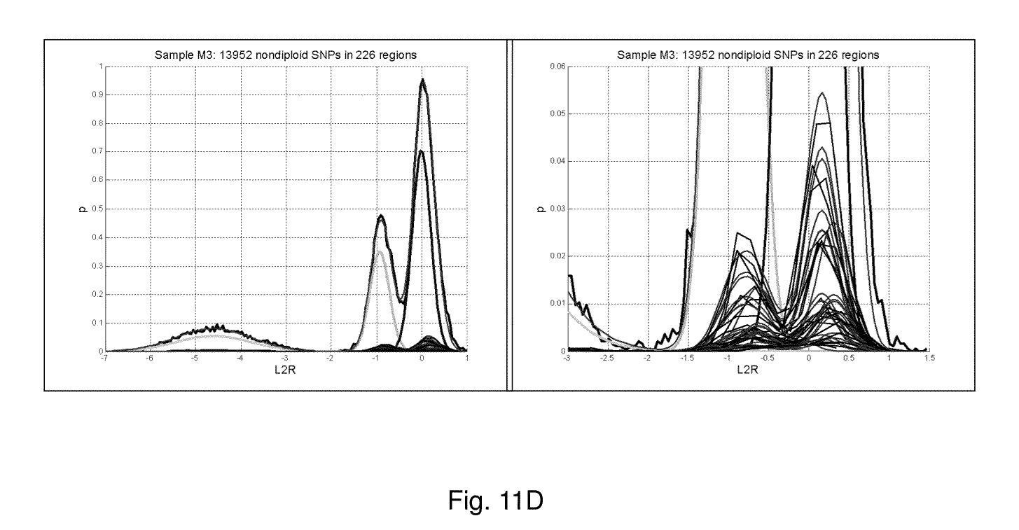

The workflow for generating the Gaussian SNP log ratio distributions expected in aberrant regions is illustrated in FIG. 11A-D. First, the genome is divided into regions of constant total copy number, using the CGH data as described above, and the aneuploid fraction is determined. Then, log ratios of SNP probes in diploid regions are fitted to three Gaussian peaks, as for normal diploid samples (FIG. 2B, FIG. 11A), then scaled (i.e., multiplied by a constant) in intensity by the fraction of all SNP probes that are in diploid regions. For each aneuploid region i of total copy number Nᵢ, we expect AsCN values of 0, 1+f(mᵢ−1), 1+f(Nᵢ−mᵢ−1), and 2+f(Nᵢ2), where f is the aneuploid fraction and mᵢ is the integer number of copies of the least abundant parental chromosome in the aberrant region (0<=mᵢ<=Nᵢ/2). The Gaussian distributions of log ratios expected for SNPs having these net AsCNs can be computed from the three distributions fitted in the diploid regions. In particular, the distribution for AsCN=0 is the same as that in diploid regions, and:

μ₁ₐ′=log₂(s(f(mᵢ−1)−1)/2+2^{μ2}),

μ_{1b}′=log₂(s(f(Nᵢ−mᵢ−1)−1)/2+2^{μ2}),

μ₂′=log₂(sf(Nᵢ−2)x/2+2^{μ2}),

where μ₁ and μ₂ are the centers of the Gaussian fits to the AsCN=1 and AsCN=2 peaks in the diploid regions, and the slope s=2(2^{μ2}−2^{μ1}) accounts for the log ratio compression of the assay. The widths, σⱼ, of the shifted Gaussians are set equal to σ₂ if μ′>μ₁ and to σ₁ otherwise. The coefficients are multiplied by the fraction of all SNP probes in the aberration, and further by 0.5 for μ₁ₐ′ and μ_{1b}′. In each region, distributions are generated for all possible values of mᵢ, and we choose the mᵢ which best fits the observed log ratio distribution in the region. As a check on the success of the model, the sum of all the regional Gaussian distributions is compared with the observed distribution (FIG. 11D).

Estimate Expected AsCN

The mosaic model assumes that each SNP in the aneuploid fraction is in one of up to four regionally defined AsCN states (0, mᵢ, Nᵢ−mᵢ, Nᵢ), and has a conditional log ratio probability distribution p(LRISα) for each state α. The likelihood that each SNP site is in each state is then computed by applying Bayes' rule:

L(S_{α}|LR)=p(LR|S_{α}) p(S_{α})/p(LR),

where p(LRIS_{α}) p(S_{α})=coeff(α)*N(LR,μ_{α},σ_{α}), and p(LR) is the sum of all the Gaussian probability densities evaluated at LR.

The expectation value of the AsCN is reported as that of the aberrant genotype:

E(AsCN|LR)=Σ_{α}S_{α}L(Sα|LR).

### LOH Calls

Regions of LOH include all regions for which mᵢ=0. Any deleted region is necessarily LOH. If the region is amplified, the value of mᵢ is determined during the AsCN calling. However, in copy-neutral (i.e. diploid) regions, we need a separate algorithm to call LOH and mosaic LOH regions, since these regions are not identified and delimited by the CGH copy number analysis.

Once the expected AsCN has been computed, we classify each probe as homozygous or heterozygous. All genomic intervals are scored using a hypergeometric surprise function, which identifies regions having a surprisingly low incidence of heterozygous calls. Such regions are called as constitutive LOH. In diploid regions of mosaic LOH, the SNP LRs fall into four clusters, rather than three as in normal diploid regions, or two as in constitutive LOH regions. If the mosaic fraction is greater than 50%, the mosaic homozygous probes will have a net AsCN closer to zero or two than to one, and the above algorithm will detect such regions. If the mosaic fraction is <50%, then the region can be identified by discovering a splitting in the distribution of nominally heterozygous SNPs.

### Supplemental Methods

CGH copy number assignments: Weighted regression on all CN regions. For a male reference, only auto somes are included. Heuristic assignment of CN to LR peaks. User override allowed here. The aneuploid fraction is determined here. The assumption that there is a dominant aneuploid clone is also tested here—if this fails, we may well abort the rest of the analysis.

Consider a biclonal sample, in which a single aberrant clone is mixed with diploid normal cells. Let f be the fraction of tumor cells (aberrant clone) in the sample, and N be the integral copy number in a genomic region of the tumor clone. Then the copy number of the mixed sample in this region is given by fN+2(1−f), and the observed ratio of test/reference signal in a peak of the centralization curve will be: ratio=(N/2−1)*f+1. A copy number plot is expected to have a slope of f, rather than 1.0 as for a monoclonal sample (see FIG. 6B). When analyzing a polyclonal sample, there's a bit more ambiguity about copy number assignments than for a monoclonal sample, since the slope of the copy number plot can only be used to bound, but not to determine, the absolute assignments of log ratio peak assignments to copy numbers. However, if the predominant ploidy or the fraction of normal cells is known from other evidence (e.g. cytogenetics or cytological data), a robust copy number assignment can be made. In any case, tentative copy number assignments can be evaluated based on how well the SNP probes in assigned diploid regions conform to the expected three log ratio peaks.

CGH smoothing and Gaussian fits: The CGH data are smoothed to a nominal mean noise level equal to some fraction of the peak spacing, e.g., which may be in the range of 0.01 to 0.1, e.g., typically 0.04 if aneuploid fraction>0.5, and 0.025 otherwise. Typically the smoothing is not allowed to exceed 100 points.

SNP reference adjustment: Log ratios of SNP probes are adjusted for the known AsCN of the reference. If the reference has zero uncut alleles, the SNP LR is NaN. If there are more than one SNP probes, their LRs are averaged. The results are SNP LRs.

SNP diploid Gaussian fits: The SNP LRs of SNPs in diploid genomic regions are fit to three Gaussians at N=0, 1, 2. We compute the likelihood that each of these probes has allele-specific copy number (AsCN) 0, 1, or 2, based on these Gaussian fits.

SNP calls from signal: The log base 2 of the raw (i.e. unreferenced) sample signal is fit to two Gaussians, one for all diploid probes called AsCN=0, and the other for diploid probes called AsCN>0 (Note: AsCN=1 and AsCN=2 are not distinguishable based on signal alone). The likelihood that each SNP is actually AsCN=0 is computed using the Gaussian fits. SNPs with likelihood<0.9 of being AsCN=0 are left uncalled.

SNP calls in aneuploid regions: In each aberrant region i, the aberrant clone comprises mᵢ copies of one “parental” genome, and Nᵢ−mᵢ copies of the other, with mᵢ<=Nᵢ/2 The aberrant clone contributes a fraction of the cells f, with the remaining 1−f cells diploid normal (the minor complication introduced by chrX probes in males will be ignored here). By assumption, if the normal genotype is aa (doubly cut) at a SNP site, the aberrant clone will also be doubly cut, and the same for bb. So we expect to see net AsCNs of 0 and fNi+2(1−f) in the mixture. If the normal clone is heterozygous at a SNP site, the aberrant clone will contain mᵢ copies of one allele, and Nᵢ−mᵢ copies of the other. So the observed net AsCN will be either fmᵢ+(1−f) or f(Nᵢ−mᵢ)+(1−f), depending on whether the a or b allele contributes the most copies to the aberrant clone. Therefore we expect in general to see four different log ratio peaks in each region, corresponding to 0,f mᵢ+1−f(Nᵢ−mᵢ)+1−f, and fNᵢ+2−2f copies of the uncut allele.

Both Nᵢ and f are known from the CGH copy number fits, and the positions, widths and relative intensities of the Gaussians corresponding to 0, 1, and 2 copies are known. We generate artificial Gaussians at the appropriate LR and intensity, and compute Bayesian likelihoods for each SNP in the aberration. Only the integer value of m must be fitted for each aberration, so very small aberrations can be robustly genotyped.

The widths of the generated artificial Gaussians are estimated from a simple error model including a constant and a proportional error term in each channel. In general, distributions of LRs for N>2 are nearly identical to the N=2 Gaussian, and peaks corresponding to lower net AsCN are broader, as the signal to noise ratio in the numerator approaches zero. We use this error model to apply width corrections for generated artificial Gaussians corresponding to net AsCN<2. In practice, however, this correction has a minor effect on AsCN likelihood calls.

In some regions we may fail to observe the expected number or positions of peaks. This can occur when one of the three assumptions is violated in the region. At present, such regions are flagged for manual attention, and not further analyzed.

Report SNP genotypes and haplotypes: All SNP probes whose expected AsCN exceeds a user-supplied confidence threshold (e.g. 0.95) are assigned genotypes. Some SNPs may be assigned partial genotypes (i.e. if we are confident that there's one copy of an allele in a diploid region, but not confident that there are two, we can call the genotype e.g. GN). Since the AsCN is reported for both the normal and aberrant clones in mosaic samples, the haplotype can also be determined for aberrant regions with deletions or unbalanced amplifications.

LOH detection: Regions of LOH include all regions for which mᵢ=0. Any deleted region is necessarily LOH. If the region is amplified, the value of mᵢ is determined during the AsCN calling. However, in copy-neutral (i.e. diploid) regions, we need a separate algorithm to call LOH and mosaic LOH regions, since these regions are not identified and delimited by the CGH copy number analysis.

Copy neutral mosaic LOH detection: Once expected AsCN has been computed, we classify each probe as homozygous or heterozygous. All genomic intervals are scored using a hypergeometric surprise function, which identifies regions having a surprisingly low incidence of heterozygous calls. Such regions are called as constitutive LOH. In diploid regions of mosaic LOH, the SNP LRs fall into four clusters, rather than three as in normal diploid regions, or two as in constitutive LOH regions. If the mosaic fraction is greater than 50%, the mosaic homozygous probes will have a net AsCN closer to zero or two rather than one, and the above algorithm will detect such regions. If the mosaic fraction is <50%, then the region can be identified by discovering a splitting in the distribution of nominally heterozygous SNPs.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of genotyping, comprising:
a) obtaining a plurality of ratios indicating which alleles of a plurality of single nucleotide polymorphisms (SNPs) are present in diploid regions of a test genome and a reference genome;
b) calculating a plurality of probability distribution functions that fit said plurality of ratios; and
c) estimating the allele-specific copy number of a SNP of said test genome using said plurality of probability distribution functions. SNP in diploid region

2. The method of claim 1, wherein said calculating of step b), comprises:
calculating a first probability distribution function for SNP alleles in diploid regions of said test genome that have a copy number of 0 for SNP alleles that have a reference copy number of 1 or 2;
calculating a second probability distribution function for SNP alleles in diploid regions of said test genome that have a copy number of 1 for SNP alleles that have a reference copy number of 1 or 2; and
calculating a third probability distribution function for SNP alleles in diploid regions of said test genome that have a copy number of 2 for SNP alleles that have a reference copy number of 1 or 2.

3. The method of claim 1, wherein said SNP is in a diploid region of said test genome.

4. The method of claim 1, wherein said SNP is in a non-diploid region of said test genome.

5. The method of claim 1, wherein said method further comprises comparing said test and reference genomes to obtain CGH data.

6. The method of claim 5, further comprising identifying a copy number neutral loss of heterozygosity (LOH) event in said test genome.

7. The method of claim 1, wherein said genome is diploid.

8. The method of claim 1, wherein said genome comprises non-diploid regions.

9. The method of claim 1, wherein a test sample used to produce said ratios is mosaic.

10. The method of claim 1, further comprising calculating a likelihood score indicating the confidence that said allele-specific copy number of said SNP has been correctly assigned, wherein said score is calculated using said plurality of probability distribution functions.

11. The method of claim 10, further comprising calculating an expectation value for said allele-specific copy number.

12. The method of claim 1, comprising:
estimating the allele-specific copy numbers for a plurality of individual SNPs to provide a dataset of allele-specific copy number estimates; and
calculating likelihood scores for said allele-specific copy numbers that the confidence that said allele-specific copy numbers have been correctly assigned, wherein said scores are calculated using said plurality of probability distribution functions.

13. The method of claim 1, wherein said ratios are obtained by hybridizing said test and reference genome to an array comprising oligonucleotides that discriminate between different alleles of a SNP.

14. The method of claim 12, further comprising removing allele-specific copy number estimates from said dataset if their likelihood scores are below a threshold.

15. The method of claim 1, further comprises comparing said test and reference genomes to obtain CGH data and aligning said CGH data with the allele-specific copy number of a plurality of individual SNPs along a physical map to produce an alignment.

16. The method of claim 15, further comprising identifying a chromosomal aberration using said alignment.

17. The method of claim 1, wherein said ratios are log₂ ratios.

18. The method of claim 1, comprising:
a) subjecting a mosaic test sample to CGH and SNP analysis to obtain:
i. CGH data indicating which parts of said test genome are diploid and which parts are non-diploid; and
ii. SNP data comprising ratios indicating the allele-specific copy number of a plurality of SNPs that are present in diploid regions of said test genome;
iii. SNP data comprising ratios for a plurality of SNPs that are present in a non-diploid region of said genome;
b) calculating the fraction of cells in said mosaic sample that are non-diploid using said CGH data;
c) calculating a plurality of probability distribution functions that fit said ratios; and
d) estimating the allele-specific copy number of SNPs in said non-diploid region of said test genome using i. said probability distribution functions, ii. said fraction and iii. the ratios for SNPs that are present in said non-diploid region of said genome.

19. The method of claim 18, wherein said estimating comprises:
i. modeling a plurality of expected distribution functions using: i. said probability distribution functions, and ii. said fraction; and
ii. fitting said ratios for SNPs that are present in said non-diploid region of said genome to said expected distribution functions; and
iii. determining which of said expected distribution functions most closely matches said ratios for SNPs that are present in said non-diploid region of said genome.

20. A tangible computer readable medium comprising instructions for performing the method of claim 1.
